(19) United States
(12) Patent Application Publication
(10) Pub. No.: US 2022/0269540 A1
(43) Pub. Date: Aug. 25, 2022

(54) NVMe POLICY-BASED I/O QUEUE ALLOCATION

(71) Applicant: Seagate Technology LLC, Fremont, CA (US)

(72) Inventor: Marc Timothy Jones, Longmont, CO (US)

(21) Appl. No.: 17/184,878

(22) Filed: Feb. 25, 2021

(51) Int. Cl. G06F 9/50; G06F 13/16; G06F 13/42

(52) U.S. Cl. CPC G06F 9/5011; G06F 13/1668; G06F 13/4282; G06F 2213/0026

(57) ABSTRACT

A multi-function NVMe subsystem includes a plurality of primary controllers, and a plurality of queue resources. The multi-function NVMe subsystem also includes a plurality of policies with each different policy of the plurality of policies differently dictating how the plurality of queue resources is divided amongst different primary controllers of the plurality of primary controllers.

### SUMMARY

In one embodiment, a multi-function non-volatile memory express (NVMe) subsystem is provided. The multi-function NVMe subsystem includes a plurality of primary controllers with each primary controller of the plurality of primary controllers being pre-allocated with a predetermined number of queue resources. A first primary controller of the plurality of primary controllers is configured to, after initialization, identify a first number of queue resources to be utilized by the first primary controller, and to request fewer queue resources than the predetermined number of queue resources allocated to the first primary controller when the first number of queue resources is less than the predetermined number of queue resources pre-allocated to the first primary controller. The first primary controller is further configured to reallocate any remaining queue resources pre-allocated to the first primary controller to a global queue resource pool for utilization by a different primary controller of the plurality of primary controllers.

In another embodiment, a method of managing queue resources in a multi-function NVMe subsystem is provided. The method includes pre-allocating a predetermined number of queue resources to each primary controller of a plurality of primary controllers of the multi-function NVMe subsystem. The method also includes identifying a first number of queue resources to be utilized by a first primary controller of the plurality of primary controllers. The method further includes requesting fewer queue resources than the predetermined number of queue resources allocated to the first primary controller when the first number of queue resources is less than the predetermined number of queue resources pre-allocated to the first primary controller, and reallocating any remaining queue resources pre-allocated to the first primary controller to a global queue resource pool for utilization by a different primary controller of the plurality of primary controllers.

In yet another embodiment, a multi-function NVMe subsystem is provided. The multi-function NVMe subsystem includes a plurality of primary controllers, and a plurality of queue resources. The multi-function NVMe subsystem also includes a plurality of policies with each different policy of the plurality of policies differently dictating how the plurality of queue resources is divided amongst different primary controllers of the plurality of primary controllers.

This summary is not intended to describe each disclosed embodiment or every implementation of the NVMe policy-based input/output (I/O) queue allocation described herein. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a simplified block diagram of a computing system that includes a non-volatile memory express (NVMe) subsystem in accordance with one embodiment.

FIG. 2 is a simplified block diagram showing a general canonical architecture of an NVMe system.

FIG. 3 is a simplified block diagram of an NVMe subsystem illustrating queue management and queue resource allocation in accordance with an embodiment of the disclosure.

FIGS. 4A-4C are block diagrams that together illustrate an example of a global pool policy.

FIG. 5 is a block diagram that illustrates an example of a static allocation policy.

FIGS. 6A-6C are block diagrams that together illustrate an example of an elastic allocation policy.

### DETAILED DESCRIPTION OF ILLUSTRATIVE EMBODIMENTS

Embodiments of the disclosure generally relate to queue resource management in non-volatile memory (NVM) subsystems, which utilize a NVM Express (NVMe) interface to enable host software to communicate with the NVM subsystem. The NVM subsystem that employs the NVMe interface is hereinafter referred to as a NVMe subsystem. The NVMe subsystem may include a single data storage device (e.g., a single solid state drive (SSD)) or a plurality of data storage devices.

In general, prior NVMe SSD designs statically divide available queue resources across controllers within the NVMe subsystem. This works in some customer use-cases, but lacks flexibility for more complex customer models (such as special controller models that include administrative controllers).

Embodiments of the disclosure provide for flexible queue resource management in multi-function NVMe subsystems. A function, or peripheral component interconnect (PCI) function, represents an endpoint in a PCI device. A host attaches a driver to the function where the function exposes a protocol based upon the type of function (storage device, network device, display device, etc.). There may also be multiple functions that each expose the same protocol (such as a mass storage device using the NVMe protocol). A PCI function represents a single “controller” within the NVMe subsystem. In NVMe subsystems with multiple functions, each function has its own primary controller, and different numbers of queue resources may be suitable for the different primary controllers. In other words, there may be some asymmetry for different primary controller types (for example, an administrative controller or discovery controller may employ only one administrative queue resource, whereas input/output (I/O) controllers may generally employ a queue resource per central processing unit (CPU) core of the host system to which they are attached (plus an administrative queue resource)). It should be noted that, in some embodiments, all primary controllers of the NVMe subsystem may be I/O controllers, by different I/O controllers may employ different numbers of queue resources.

Embodiments of the disclosure modify the manner in which queue resources are allocated to a given controller through a policy, which is described further below. As indicated above, past designs have implemented the static allocation policy, but richer policies are also provided herein to tailor the behavior of the controller for queue resource allocation. This policy-based approach is compatible with existing mechanisms defined in a current NVMe specification.

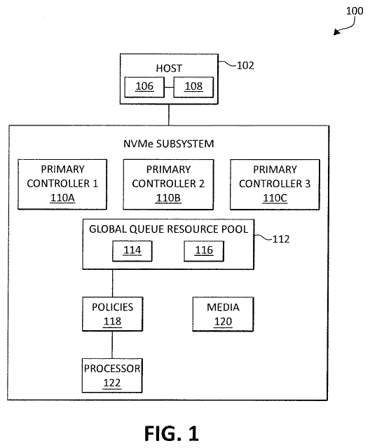

FIG. 1 shows an illustrative operating environment in which certain specific embodiments disclosed herein may be incorporated. The operating environment shown in FIG. 1 is for illustration purposes only. Embodiments of the present disclosure are not limited to any particular operating environment such as the operating environment shown in FIG. 1. Embodiments of the present disclosure are illustratively practiced within any number of different types of operating environments.

It should be noted that like reference numerals are used in different figures for same or similar elements. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It will be understood that, when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings or attachments between elements also include embodiments, in which the elements are indirectly connected, coupled or attached to each other.

FIG. 1 is a simplified block diagram that shows a computing system 100 in which a host computer (or simply host) 102 is coupled to a NVMe subsystem 104 through either a wired or wireless connection. Host 102 represents any type of computing system that is configured to read data from and write data to a data storage device. Examples of host 102 include cloud computing environments, servers, desktop computers, laptop computers, mobile phones, tablet computers, televisions, automobiles, or any other type of mobile or non-mobile computing device that is configured to read and write data. In general, host 102 may include a central processing unit (CPU) 106, which is coupled to one or more memories 108. CPU 106 may include one or more cores.

As indicated above, NVMe subsystem 104 may include a single data storage device (e.g., a single solid state drive (SSD)) or a plurality of data storage devices. In the embodiment of FIG. 1, NVMe subsystem 104 is shown as including 3 primary controllers 110A, 110B and 110C, which are implemented in hardware. In general, any suitable number of controllers (greater than 3 or less than 3) may be employed in different embodiments. Each primary controller 110A, 110B, 110C may have an allocation of queue resources, and each queue resource may include a submission queue and a completion queue resource pair. In systems that utilize NVMe interfaces, submission queues are employed to receive commands, and completion queues are employed to send completions or responses when the received commands are completed/executed by the NVMe subsystem such as 104. From a perspective of the host 102, the submission queue is utilized to send commands to the NVMe subsystem 104, and the completion queue is used to receive responses for commands from the NVMe subsystem 104. It should be noted that, in some embodiments, multiple submission queues may point to a single completion queue and therefore, in such embodiments, a queue resource may include multiple submission queue resources and a single completion queue resource.

In the embodiment of FIG. 1, a global queue resource pool of NVMe subsystem 104 is shown as block 112. Global queue resource pool 112 may include queue resources 114, which may be implemented in hardware, and a global queue resource counter 116 that represents the available global queue resources 114. NVMe subsystem 104 also includes policies 118, which dictate how many queue resources are to be provided to a particular controller 110A, 110B, 110C. The policies 118 may comprise firmware instructions stored in memory and/or on media 120 of NVMe subsystem 104. In on embodiment, media 120 may comprise solid-state memory. A processor 122 may execute the firmware instructions to select and implement different ones of the policies 118. The policy can be defined/selected in a number of ways. Some examples for selecting the policy are as follows:

1) A default policy, which can be changed later in the field, may be set within the NVMe subsystem 104 before shipping.
2) The policy may be selected through a command from the host 102. The selection is enacted once the NVMe subsystem 104 is reset.
3) The policy may be selected through a side-band management channel (such as System Management Bus (SMBus) or PCI Vendor Defined Message (VDM) using the Management Component Transport Protocol (MCTP)).
Table 1 below shows examples of different policies 118.

TABLE 1

| Policy | Description |
|---|---|
| Global Pool Policy | Queue resources are allocated from a global pool |
| | (e.g., 112) in a first-come-first-served basis. |
| Static Allocation | Queue resources are pre-allocated to controllers |
| Policy | (e.g., 110A, 110B, 110C) statically (canonical |
| | policy). This can be evenly divided between |
| | controllers (e.g., 110A, 110B, HOC), or using |
| | some other distribution. |
| Elastic Allocation | Queue resources are pre-allocated to controllers |
| Policy | (e.g., 110A, 110B, HOC), but once a controller |
| | has configured queues, any queue resources |
| | unused by a controller may be elastically used by |
| | other controllers. |

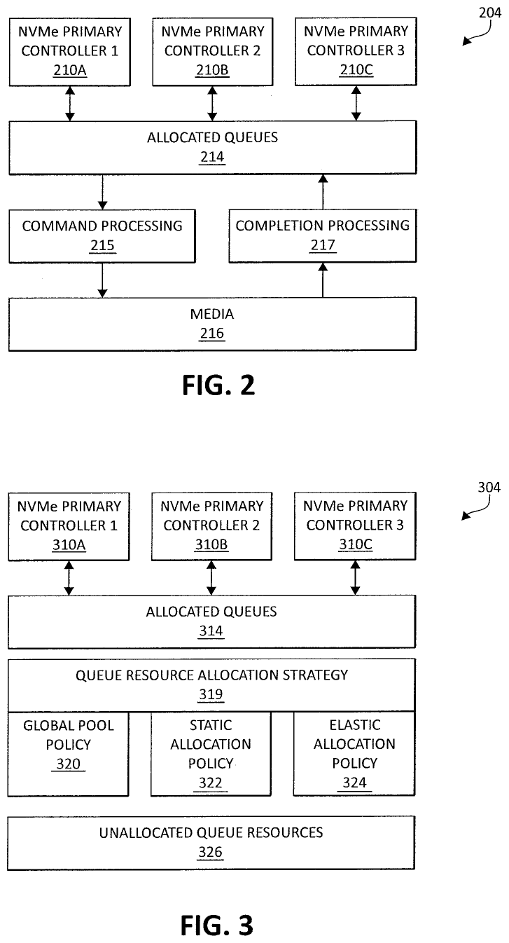

In an initial state of NVMe subsystem 104, before the controllers 110A, 110B, 110C are initialized, all of the queue resources are unallocated. Then, once the controllers 110A, 110B, 110C are initialized, based upon the policy 118, the controllers 110A, 110B, 110C receive a number of queues that they can create and advertise to the host 102. In some environments (e.g., a server environment), host 102 may allocate a queue to each CPU 106 core. Processor 120 may be configured to update a table (not shown) in NVMe subsystem 104 that is utilized to track queue resource allocation for each controller 110A, 110B, 110C. It should be noted that the definition of the queues and the arbitration or management of the queues exist within the NVMe subsystem 104, but the memories of the queues themselves (e.g., that memories that store the host 102 commands to be processed by NVMe subsystem 104 and command completion notifications from NVMe subsystem 104) exist in host 102 memory (e.g., in memory 108). A canonical architecture of an NVMe subsystem is briefly described below in connection with FIG. 2. Thereafter, the different queue resource allocation policies are described in connection with FIGS. 3-6C.

FIG. 2 is a simplified block diagram showing a general canonical architecture 204 of an NVMe system such as 104 of FIG. 1. In architecture 204, controllers 210A, 210B and 210C provide an interface to a host (such as 102 of FIG. 1) and have some number of allocated queues 214. Through the queues 214, commands are posted by the host (via a submission queue) and are processed in command processing block 215 by a media layer 216. The media layer 216 completes the commands in completion processing block 217 and posts completions (via a completion queue). The queue resources make up the queue pairs (e.g., submission and completion queue pairs) that are to be managed by the allocation policy.

FIG. 3 is a simplified block diagram of an NVMe subsystem portion 304 illustrating queue management and queue resource allocation in accordance with an embodiment of the disclosure. In the interest of simplification, media and associated command processing and command completion blocks are not shown in FIG. 3. Controllers 310A, 310B and 310C desire allocation of queues. As noted above and shown in Table 1, a queue allocation policy defines how queues are to be allocated to controllers 310A, 310B and 310C. One of a plurality of policies may be set during, for example, initialization of NVMe subsystem 104. For example, a queue resource allocation strategy 319 may involve selecting one of the queue resource allocation policies listed in Table 1 above, and shown in FIG. 3 as block 320, 322 and 324. The selected policy 320, 322 or 324 arbitrates how many queues are allocated to a given controller 310A, 310B, 310C. The allocated queues are denoted by reference numeral 314, and any remining unallocated queue resources are denoted by reference numeral 326.

Queues may be allocated through a NVMe get/set feature called “Number of Queues.” It should be noted that this is from the host perspective. The host will allocate queues for use, but internally in the NVMe subsystem the queue resources are allocated to a controller for host allocation. The host may use a “Set Number of Queues” feature to identify how many queues that it wants for a given controller 310A, 310B, 310C. The NVMe subsystem 304 responds with the number of queues that are available for that controller 310A, 310B, 310C. As indicated above, in embodiments of the disclosure, the allocation policy defines how many queues a given controller 310A, 310B, 310C may receive.

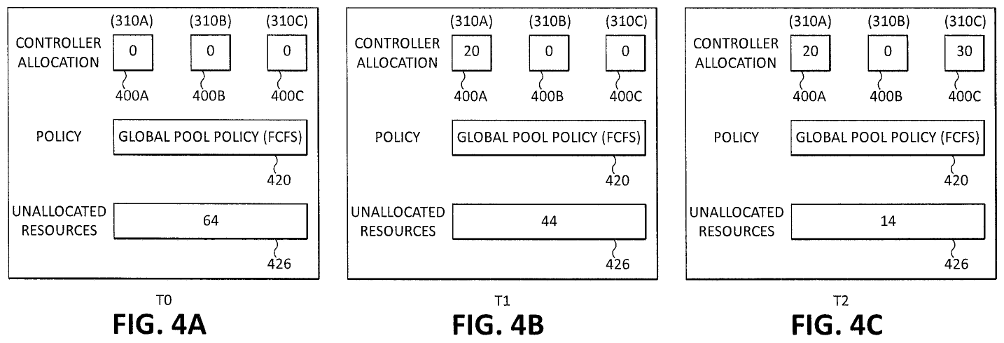

FIGS. 4A-4C are block diagrams that together illustrate an example of a global pool policy 420 (equivalent to 320 of FIG. 3). Controller allocations 400A, 400B and 400C show how many queues are allocated for a given controller (for 3 controllers such as 310A, 310B and 310C of FIG. 3). The queue resource allocation policy is a global pool policy 420 where allocation takes place on a first come first served (FCFS) basis. Unallocated queue resources are denoted by reference numeral 426. Initially, all controller queue resource allocations 400A, 400B, 400C are zero (time-0 (T0)) as shown in FIG. 4A. At time-1 (T1) shown in FIG. 4B, a first controller (e.g., controller 310A of FIG. 3) requests 20 queues, and since there are at least 20 available queue resources, 20 queue resources are allocated for the first controller. At time-2 (T2), a third controller (e.g., controller 310C of FIG. 3) requests 30 queue resources, and since 44 queue resources are available, the requested 30 queue resources are provided to the third controller. This leaves 14 queue resources available, which can be allocated for, for example, a second controller (e.g., controller 310B of FIG. 3). It should be noted that if the second controller 310B requests more than 14 queue resources, the queue allocator (e.g., processor 122 of FIG. 1) will respond with 14 queue resources as that is all that is available.

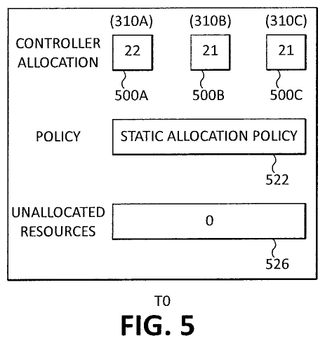

FIG. 5 is a block diagram that illustrates an example of a static allocation policy 522 (equivalent to 322 of FIG. 3). In this policy 522, queue resources may be divided amongst a number of controllers (e.g., controllers 310A, 310B and 310C of FIG. 3) during initialization, before the controller is exposed to the host. This is sometimes referred to herein as pre-allocation. For example, controller 310A may be pre-allocated 22 queue resources (denoted by reference numeral 500A), and controllers 310B and 310C may each be pre-allocated 21 queue resources (denoted by reference numerals 500B and 500C, respectively). After initialization, when a controller 310A, 310B, 310C requests a number of queue resources, the queue allocator will simply return the number of queue resources (from unallocated queue resources 526) that are available to that controller 310A, 310B, 310C.

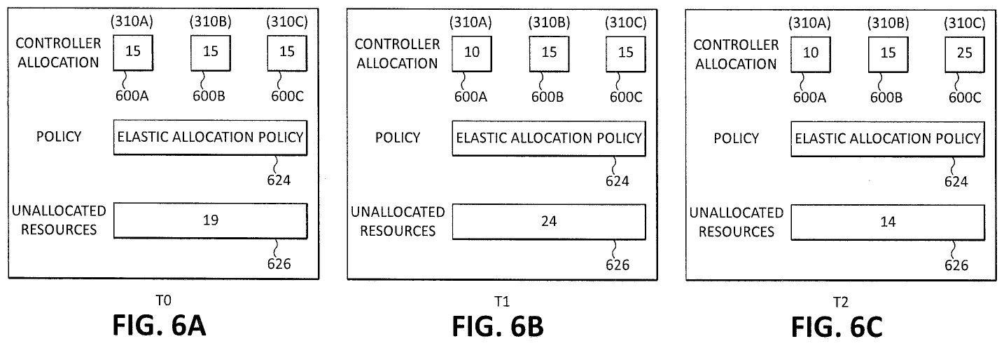

FIGS. 6A-6C are block diagrams that together illustrate an example of an elastic allocation policy 624 (equivalent to 324 of FIG. 3). In this policy 624, the controllers (e.g., controllers 310A, 310B and 310C of FIG. 3) are pre-allocated some number (600A, 600B, 600C) of queue resources (predefined by the queue allocator). When a host requests a number of queue resources for the controller 310A, 310B, 310C, it will be granted as long as it is less than or equal to the number of queue resources pre-allocated to the controller 310A, 310B, 310C plus unallocated queue resources 626. Once an allocation occurs, and unallocated queue resources are used, the unallocated queue resources 626 are decremented accordingly. Additionally, if the host requests fewer queue resources than are available through pre-allocation to the controller 310A, 310B, 310C, the difference is added back to unallocated queue resources 626. In FIG. 6A, at T0, controllers 310A, 310B, 310C are each pre-allocated with 15 queue resources, and therefore 19 out of a total of 64 queue resources remain unallocated. At T1, the host requests 10 queue resources for first controller 310A. The requested queue resources are 5 less than the queue resources available to controller 310A. Thus, the 5 remaining queue resources (difference between 10 and 15 queue resources) are added to the pool of unallocated resources 626, thereby increasing the total number of unallocated resources 626 from 19 to 24. At T3, the host requests 25 queue resources for third controller 310C. Since third controller 310C is pre-allocated with 15 queue resources, 10 queue resources have to be obtained from the unallocated queue resources 626. Since the available unallocated queue resources are 24, 10 out of those available queue resources are provided to the third controller 310C. It should be noted that, if less than 10 queue resources were available in the unallocated queue resource pool 626, the queue resources to the extent available would be provided to third controller 310C.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A multi-function non-volatile memory express (NVMe) subsystem comprising:
a plurality of primary controllers with each primary controller of the plurality of primary controllers being pre-allocated with a predetermined number of queue resources; and
a first primary controller of the plurality of primary controllers configured to, after initialization, identify a first number of queue resources to be utilized by the first primary controller, and to request fewer queue resources than the predetermined number of queue resources allocated to the first primary controller when the first number of queue resources is less than the predetermined number of queue resources pre-allocated to the first primary controller, and to reallocate any remaining queue resources pre-allocated to the first primary controller to a global queue resource pool for utilization by a different primary controller of the plurality of primary controllers.

2. The multi-function NVMe subsystem of claim 1 and wherein the predetermined number of queue resources is a same number of queue resources for each different primary controller of the plurality of different primary controllers.

3. The multi-function NVMe subsystem of claim 1 and wherein the plurality of primary controllers comprises at least two different types of primary controllers.

4. The multi-function NVMe subsystem of claim 3 and wherein the at least two different types of primary controllers comprises an input/output controller and an administrative controller.

5. The multi-function NVMe subsystem of claim 3 and wherein the predetermined number of queue resources comprises different numbers of queue resources for the at least two different types of primary controllers.

6. The multi-function NVMe subsystem of claim 1 and wherein the first primary controller is further configured to request a greater number of queue resources than the predetermined number of queue resources allocated to the first primary controller from the global queue resource pool when the first number of queue resources is greater than the predetermined number of queue resources allocated to the first primary controller.

7. The multi-function NVMe subsystem of claim 6 and wherein the first primary controller is configured to, in response to the request for the greater number of queue resources, receive queue resources from the global queue resource pool that are less than or equal to a difference in queue resources between the first number of queue resources and the predetermined number of queue resources allocated to the first primary controller.

8. A method of managing queue resources in a multi-function non-volatile memory express (NVMe) subsystem, the method comprising:
pre-allocating a predetermined number of queue resources to each primary controller of a plurality of primary controllers of the multi-function NVMe subsystem;
identifying a first number of queue resources to be utilized by a first primary controller of the plurality of primary controllers; and
requesting fewer queue resources than the predetermined number of queue resources allocated to the first primary controller when the first number of queue resources is less than the predetermined number of queue resources allocated to the first primary controller, and reallocating any remaining queue resources pre-allocated to the first primary controller to a global queue resource pool for utilization by a different primary controller of the plurality of primary controllers.

9. The method of claim 8 and wherein the predetermined number of queue resources is a same number of queue resources for each different primary controller of the plurality of different primary controllers.

10. The method of claim 8 and further comprising providing the plurality of primary controllers such that the plurality of primary controllers comprises at least two different types of primary controllers.

11. The method of claim 10 and wherein the at least two different types of primary controllers comprises an input/output controller and an administrative controller.

12. The method of claim 10 and wherein the predetermined number of queue resources comprises different numbers of queue resources for the at least two different types of primary controllers.

13. The method of claim 8 and further comprising requesting, by the first primary controller, a greater number of queue resources than the predetermined number of queue resources allocated to the first primary controller from the global queue resource pool when the first number of queue resources is greater than the predetermined number of queue resources allocated to the first primary controller.

14. The method of claim 13 and further comprising, in response to the request for the greater queue resources, receiving, by the first primary controller, queue resources from the global queue resource pool that are less than or equal to a difference in queue resources between the first number of queue resources and the predetermined number of queue resources allocated to the first primary controller.

15. A multi-function non-volatile memory express (NVMe) subsystem comprising:
a plurality of primary controllers;
a plurality of queue resources; and
a plurality of policies with each different policy of the plurality of policies differently dictating how the plurality of queue resources is divided amongst different primary controllers of the plurality of primary controllers.

16. The multi-function NVMe subsystem of claim 15 and wherein one policy of the plurality of policies comprises a global pool policy in which the plurality of queue resources is allocated amongst different primary controllers of the plurality of primary controllers from a global queue resource pool on a first-come-first-served basis.

17. The multi-function NVMe subsystem of claim 15 and wherein one policy of the plurality of policies comprises a static allocation policy in which the plurality of queue resources is pre-allocated amongst different primary controllers of the plurality of primary controllers based on a predetermined distribution criterion.

18. The multi-function NVMe subsystem of claim 15 and wherein one policy of the plurality of policies comprises an elastic allocation policy in which the plurality of queue resources is pre-allocated amongst different primary controllers of the plurality of primary controllers based on a pre-determined distribution criterion, and wherein the pre-allocation is modifiable after initialization of the plurality of controllers.

19. The multi-function NVMe subsystem of claim 15 and wherein the plurality of primary controllers comprises at least two different types of primary controllers.

20. The multi-function NVMe subsystem of claim 19 and wherein the at least two different types of primary controllers comprises an input/output controller and an administrative controller.
